(19) United States
(12) Patent Application Publication
(10) Pub. No.: US 2004/0097280 A1
(43) Pub. Date: May 20, 2004

(54) Gaming machine having triggering event that alters the display of symbols

(76) Inventor: Michael Gauselmann, Espelkamp (DE)

Correspondence Address: PATENT LAW GROUP LLP, 2635 NORTH FIRST STREET, SUITE 223, SAN JOSE, CA, 95134, US

(21) Appl. No.: 10/301,126

(22) Filed: Nov. 20, 2002

(51) Int. Cl. A63F 9/24; A63F 13/00; G06F 17/00; G06F 19/00

(52) U.S. Cl. 463/16

(57) ABSTRACT

A video gaming machine displays an array of symbols. If a triggering event occurs, one or more symbols in the array can be replaced with other symbols such by shifting symbols, exchanging symbols, or by other techniques. Upon occurrence of the triggering event, even the pay lines may be changed. The changing of the symbol array or the pay lines is controllable by the player or controlled automatically. Accordingly, the player is provided another chance of winning when the triggering event occurs. In one embodiment, the triggering event may be that one of the displayed symbols is a trigger symbol, such as a specially marked symbol. Other triggering events are described.

### FIELD OF THE INVENTION

This invention relates to gaming machines and, in particular, to a special feature in a video-type gaming machine that displays symbols.

### BACKGROUND

Video gaming machines that randomly select symbols for display on the video screen and grant awards to a player based upon the displayed symbol combinations are very popular. Typically, the game ends after the display of the symbols, and the player must then bet more credits in order to play again. The symbols may form a 3×1 array, having three symbols in a single row, or the display may be a two dimensional array of symbols having, for example, three rows of symbols in five columns. The granting of an award is based on the symbol combinations across pay lines extending across the array of symbols.

Although the above-described gaming machines are popular, it is desirable to create a game that achieves more player excitement to generate more revenue by the gaming machine.

### SUMMARY

In one embodiment of the invention, a video gaming machine displays an array of symbols. If one of the displayed symbols is a trigger symbol, such as a specially marked symbol, one or more symbols in the array can be replaced with other symbols such by shifting symbols, exchanging symbols, or by other techniques. Upon occurrence of the trigger symbol, even the pay lines may be changed. The changing of the symbol array or the pay lines is controllable by the player or controlled automatically. Player control can be accomplished by buttons, a joystick, a touch screen, or by other means.

Accordingly, the player is provided another chance of winning when the trigger symbol is displayed.

In other embodiments, the triggering event for the feature may be other than a trigger symbol, such as after X games, after X losing games, after a random number of games, at a random or predetermined time, or after a special symbol combination.

### BRIEF DESCRIPTION OF THE DRAWINGS

FIG. 1 is a perspective view of one type of video gaming machine that may be programmed to play the game in accordance with the present invention.

FIG. 2 is a block diagram illustrating various functional units in the machine of FIG. 1.

FIG. 3 illustrates the display on the display screen in FIG. 1 of a 5×3 array of randomly selected symbols and five pay lines to be used as an example to illustrate the effects of a trigger symbol in the array.

FIG. 4 illustrates how the trigger symbol, such as the symbol C, allows a row of symbols to be shifted to the right, with symbol wrap-around, to provide the possibility of new winning symbol combinations.

FIG. 5 illustrates how the trigger symbol allows one or more unknown symbols to be shifted into the array either from the left, the right, above, or below the array to provide the possibility of new winning symbol combinations.

FIG. 6 illustrates how the trigger symbol allows two rows of symbols to exchange positions to provide the possibility of new winning symbol combinations.

FIG. 7 illustrates how the trigger symbol allows an entire row of unknown symbols to be shifted into the array to create the possibility of new winning symbol combinations.

FIG. 8 illustrates how the trigger symbol allows the shifting of the pay line 4 in FIG. 3 to provide the possibility of new winning symbol combinations.

FIG. 9 illustrates how the trigger symbol allows the mixing up of the symbols to provide the possibility of new winning symbol combinations.

### DETAILED DESCRIPTION

Although the invention can typically be implemented by installing a software program in most types of modern video gaming machines, one particular gaming machine platform will be described in detail.

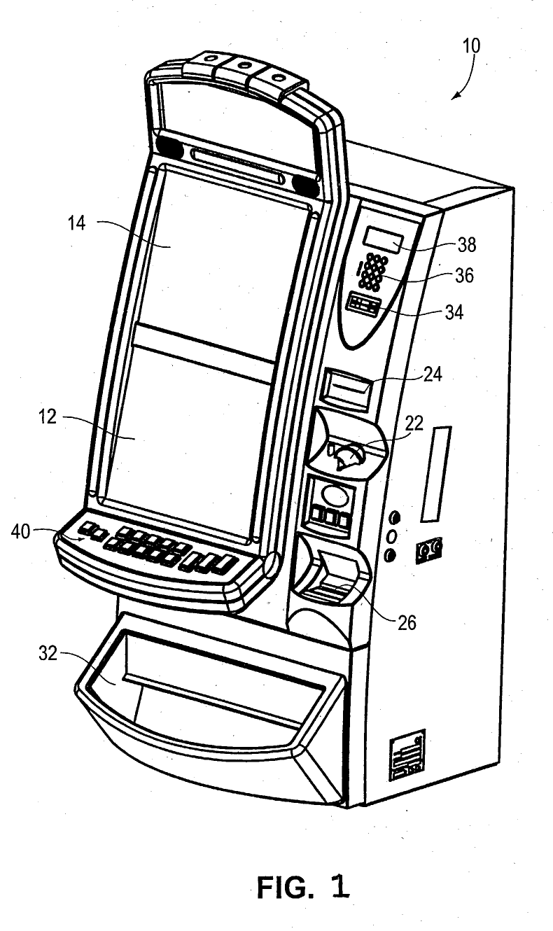

FIG. 1 is a perspective view of a gaming machine 10 that incorporates the present invention. Machine 10 includes a display 12 that may be a thin film transistor (TFT) display, a liquid crystal display (LCD), a cathode ray tube (CRT), or any other type of display. Display 12 may be a touch screen for inputting player commands. A second display 14 provides game data or other information in addition to display 12. Display 14 may provide static information, such as an advertisement for the game, the rules of the game, pay tables, pay lines, or other information, or may even display the game itself along with display 12. Alternatively, the area for display 14 may be a display glass for conveying information about the game.

A coin slot 22 accepts coins or tokens in one or more denominations to generate credits within machine 10 for playing games. A slot 24 for an optical reader and printer receives machine readable printed tickets and outputs printed tickets for use in cashless gaming. A bill acceptor 26 accepts various denominations of banknotes.

A coin tray 32 receives coins or tokens from a hopper upon a win or upon the player cashing out.

A card reader slot 34 accepts any of various types of cards, such as smart cards, magnetic strip cards, or other types of cards conveying machine readable information. The card reader reads the inserted card for player and credit information for cashless gaming. The card reader may also include an optical reader and printer for reading and printing coded barcodes and other information on a paper ticket.

A keypad 36 accepts player input, such as a personal identification number (PIN) or any other player information. A display 38 above keypad 36 displays a menu for instructions and other information and provides visual feedback of the keys pressed.

Player control buttons 40 include any buttons needed for the play of the particular game or games offered by machine 10 including, for example, a bet button, a repeat bet button, a play two-ways button, a spin reels button, a maximum bet button, a cash-out button, a display pay lines button, a display payout tables button, select icon buttons, and any other suitable button. Additional buttons that may be used with the invention include direction buttons and other control buttons that are used by the player to control shifting of the rows and/or columns in the symbol array, as described in detail below. Buttons 40 may be replaced by a touch screen with virtual buttons, a joystick, a touchpad, or other types of controllers.

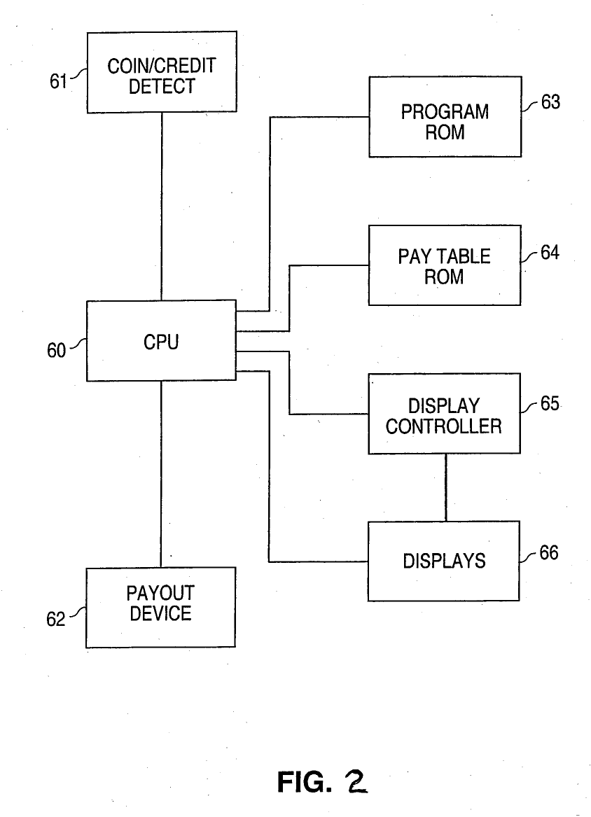

FIG. 2 illustrates basic circuit blocks in a suitable gaming device. A control unit (CPU 60) runs a gaming program stored in a program ROM 63. A coin/credit detector 61 enables the CPU 60 to initiate a next game. A pay table ROM 64 detects the outcome of the game and identifies awards to be paid to the player. A payout device 62 pays out an award to the player in the form of coins upon termination of the game or upon the player cashing out. A payout may also be in the form of a coded paper ticket, credits on a smart card or magnetic strip card, or in any other form. A display controller 65 receives commands from the CPU 60 and generates signals for the various displays 66. If a display 66 is a touch screen, player commands may be input through the display screen into the CPU 60.

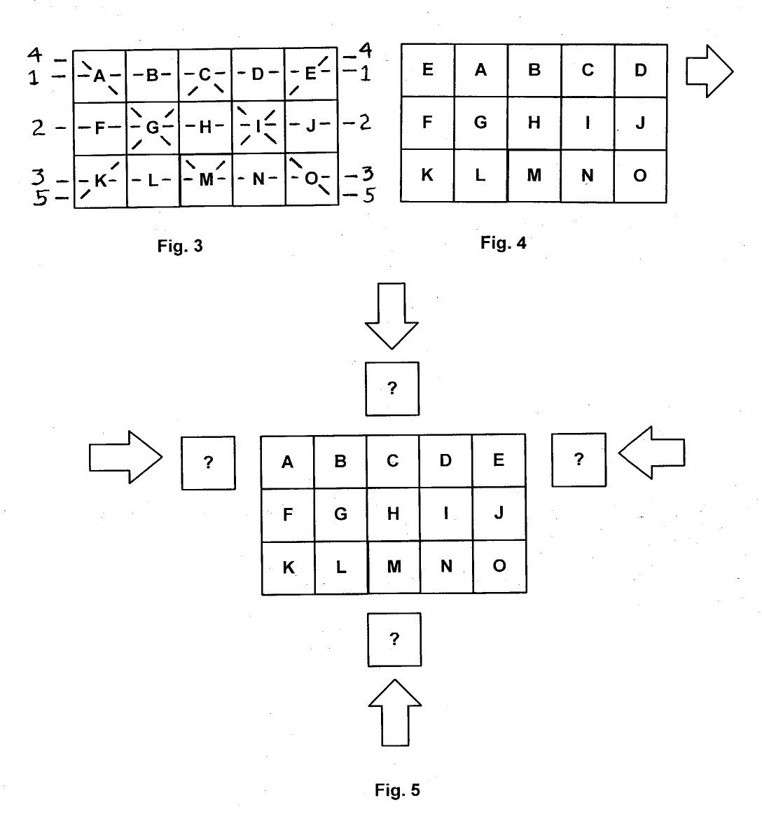

FIG. 3 is one example of a screen display on machine 10 showing five different pay lines 1-5 and an array of symbols A-O. After the player makes a bet and presses a spin button, the symbols are randomly selected by a pseudo-random number generator in the gaming machine and displayed on the display screen.

The gaming machine typically shows, either on its display glass or on a video screen, a pay table identifying the various awards that will be paid upon obtaining certain symbol combinations along activated pay lines. The player may be required to bet additional credits to activate additional pay lines. One or more special trigger symbols (or other triggering events) that provide additional features may also be identified in the pay table.

After the initial display of the symbol array of FIG. 3, the player is awarded credits or paid coins based on any winning symbol combinations across activated pay lines, in accordance with the pay table.

The present disclosure describes various possible functions that may be performed by the game upon the occurrence of a special trigger symbol in the array or upon the occurrence of another triggering event. As an example, it will be assumed that the symbol C is the special trigger symbol.

Upon the occurrence of a special trigger symbol, any of various types of events may occur. In one embodiment, the trigger symbol flashes, or other means of drawing attention to the trigger symbol is initiated. The player may then select the function of the trigger symbol, or the function may be performed automatically by the gaming machine. The display glass or a video screen may explain to the player how the trigger symbol feature works. The player may be provided with suitable buttons for controlling the feature. Alternatively, or in addition, a joy stick, touchpad, or touch screen display may be used to control the feature. The touch screen may be the main video display screen or may be a separate touch screen.

FIG. 4 illustrates one possible function of the trigger symbol. The occurrence of the trigger symbol in the top row of the array may allow the player to shift the row of symbols in either the left or right direction, one or more spaces, in order to achieve a winning combination of symbols along any of the pay lines shown in FIG. 3 (or along additional pay lines). FIG. 4 illustrates a wrap around type shift where symbols shifted off the screen pursuant to a right shift appear at the left of the row.

After the one or more shifts of the first row, the processor in the gaming machine determines whether any winning symbol combinations are displayed across a pay line, and an award, if any, is granted. The player may be provided a button or other means for indicating to the gaming machine that the player now wants the machine to evaluate the changed array of symbols for any winning combinations. In effect, shifting symbols in any direction in the array allows the player to “nudge” the symbols in order to create a winning symbol combination.

FIG. 5 illustrates a more general type of shifting upon the occurrence of the trigger symbol C. In FIG. 5, the top row (containing the trigger symbol) may be shifted to the left or to the right, or the column containing the symbol C, may be shifted up or down. The shifting may be either performed automatically or under player control. Any shift of the row or column causes new symbols to be introduced into the array to fill the 5×3 array. The player may first see the symbols to be inserted in to the array, or the symbols may remain a mystery and only revealed once they enter the array. An award is then granted for any winning symbol combinations.

In one embodiment, there may be multiple trigger symbols, where each trigger symbol allows the player to change the symbol combinations in different ways. For example, one trigger symbol may allow the player to only shift a row one position in either direction, while another trigger symbol may allow additional shifting.

If additional trigger symbols are shifted into the display, the player may get additional chances to change the display.

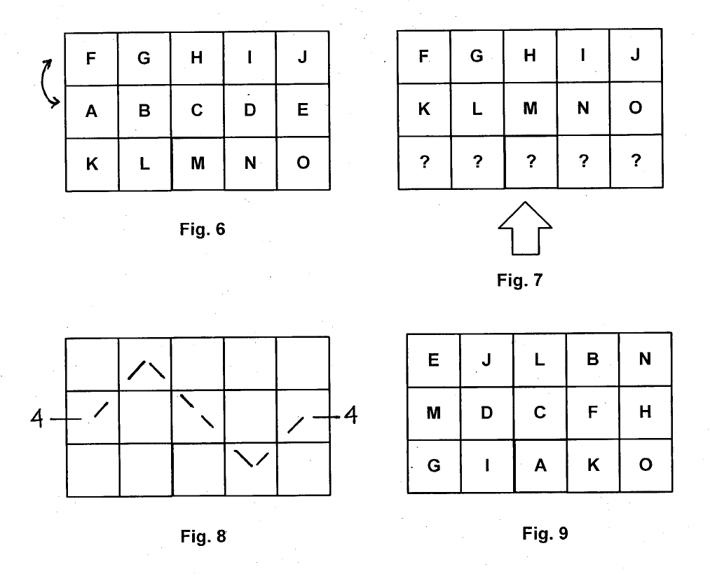

FIG. 6 illustrates a feature where, upon occurrence of the trigger symbol C in FIG. 3, the player is allowed to exchange the positions of rows. In this example, the player has transposed rows 1 and 2 in order to obtain a winning symbol combination.

FIG. 7 illustrates a function of the trigger symbol C that allows a player to shift the entire array up one row to replace the bottom row with a new row of symbols. The new symbols may be unknown to the player at the time of the shift and then revealed once the symbols are in place, or the symbols may be revealed to the player before the shifting. The existence of any new winning symbol combinations would then be determined by the machine's processor, and any awards would be granted.

Similarly, the player may shift the entire array down, to the left, or to the right to replace one or more rows or columns of symbols with new symbols. The player may get one shift or more than one shift in any direction. The player control may be by direction buttons or by any other type of controller.

In one embodiment, the player does not have to use the nudge feature at once or when activated. The player may be allowed to save “nudges” and use them later in combination or whenever she wants or after X games. For example, with three nudges saved, the player could nudge the symbols three times in the same game or use them in different games. This adds a strategic element to the game. Further, the player is likely to play the gaming machine an extended period of time while nudges are still saved up.

FIG. 8 illustrates a function of the trigger symbol that allows the player to create or shift pay lines. In the example of FIG. 8, the pay line 4 has been shifted one position to the right. The player may also choose to shift any pay line up, down, right, or left or even choose additional pay lines offered by the machine in attempt to create winning symbol combinations across a pay line.

FIG. 9 illustrates a function of the trigger symbol that allows the player to mix up the symbols to get another chance of winning. The symbols may instead be automatically rearranged by the machine.

In one embodiment, by the player shifting symbols in rows or columns, new virtual reel strips are created, wherein the arrangement of the symbols on a particular reel strip (a column) are preserved on the virtual reel that appears to rotate during each game. The player may have the option of saving the customized reel strips, such as by pressing a button to accept the change for subsequent games. Once the player's credits have been reduced to zero, such as by the player cashing out, the reel strips then go back to a default configuration. Selecting optimum reel strips involves strategy by the player, which creates additional interest in a game and gives the player a vested interest in continuing playing the same gaming machine.

In one embodiment, the player can cause the reel strips created on one machine to be downloaded to any other gaming machine connected in a network. The player may enter, via a keypad, a special code associated with the stored reel strip to recall the reel strip, or the stored reel strips may be associated with the player's tracking ID card.

Instead of a single trigger symbol, the features described herein may be initiated by a special combination of symbols, after X losing games, after X games, after a random number of games, at a random or predetermined time, after the player has wagered a certain amount, if a player tracking card indicates the player meets certain criteria, or upon any other triggering event.

Many other types of functions may be performed upon the occurrence of the triggering event, and any means may be used to carry out the function of the triggering event to give the player a second chance of winning for each game played. Accordingly, the invention makes the gaming machine more enticing than conventional gaming machines, resulting in greater revenue for the gaming machine.

Having described the invention in detail, those skilled in the art will appreciated that, given the present disclosure, modifications may be made to the invention without departing from the spirit of the inventive concepts described herein. Therefore, it is not intended that scope of the invention be limited to the specific embodiments illustrated and described.

What is claimed is:

1. A gaming method wherein an award is granted to a player for winning combinations of symbols on a display screen, the method comprising:
conducting an initial game, the initial game displaying an array of symbols on a screen;
detecting a triggering event;
carrying out a function associated with the triggering event, the function comprising changing the array of symbols to create a different arrangement of symbols to provide the player another chance to obtain a winning symbol combination; and
granting an award to the player for any winning combinations of symbols.

2. The method of claim 1 wherein an award is granted for the initial game upon the occurance of a winning combination of symbols.

3. The method of claim 1 wherein changing the array of symbols causes at least one symbol on the screen to be removed from the screen and at least one other symbol being added to the array of symbols.

4. The method of claim 1 wherein changing the array comprises shifting a row of symbols to one of the left or the right.

5. The method of claim 1 wherein changing the array comprises shifting a row of symbols to one of the left or the right.

6. The method of claim 1 wherein changing the array comprises shifting the array up, down, right, or left.

7. The method of claim 1 wherein changing the array comprises shifting a column of symbols containing the trigger symbol up, down, right, or left.

8. The method of claim 1 wherein changing the array of symbols causes at least one symbol on the screen to be removed from the screen and at least one other symbol being added to the array of symbols, the at least one other symbol to be added not being identified to the player before the at least one other symbol is added to the array.

9. The method of claim 1 wherein changing the array of symbols causes at least one symbol on the screen to be removed from the screen and at least one other symbol being added to the array of symbols, the at least one other symbol to be added being identified to the player before the at least one other symbol is added to the array.

10. The method of claim 1 wherein changing the array of symbols is controlled by the player.

11. The method of claim 1 wherein changing the array of symbols is controlled automatically.

12. The method of claim 1 wherein changing the array of symbols comprises the player pressing buttons to control the changing.

13. The method of claim 1 wherein changing the array of symbols comprises the player using a touch screen to control the changing.

14. The method of claim 1 wherein changing the array of symbols changes an order of symbols on virtual reel strips that are displayed on the gaming machine, the method further comprising the gaming machine saving in memory the virtual reel strips created by the player changing the array.

15. The method of claim 14 further comprising downloading the virtual reel strips to another gaming machine for use by the player in the another gaming machine.

16. The method of claim 1 wherein the triggering event is the display of a trigger symbol in the array of symbols.

17. The method of claim 1 wherein the triggering event is the display of a triggering combination of symbols in the array of symbols.

18. The method of claim 1 wherein the triggering event is the occurrence of a certain number of losing games played.

19. The method of claim 1 wherein the triggering event is the occurrence of a certain number of games played.

20. The method of claim 1 wherein the triggering event is a random time period.

21. The method of claim 1 wherein the triggering event is a certain time period.

22. The method of claim 1 wherein the triggering event is a random number of games.

23. The method of claim 1 further comprising the player saving up one or more functions associated with the triggering event from one or more games for use in one or more later games.

24. A gaming method wherein an award is granted to a player for winning combinations of symbols on a display screen, the method comprising:
conducting an initial game, the initial game displaying an array of symbols on a screen, certain combinations of symbols across at least one initial pay line determining an award to a player;
detecting a triggering event;
carrying out a function associated with the triggering event, the function comprising changing the at least one initial pay line to create a new pay line; and
granting an award to the player for any winning combinations of symbols across the new pay line.

25. The method of claim 24 wherein changing the at least one initial pay line to create a new pay line comprises shifting an initial pay line up, down, or sideways with respect to the array of symbols.

26. The method of claim 24 wherein changing the at least one initial pay line to create a new pay line comprises selecting a pay line that is different from all pay lines used in the initial game.

27. The method of claim 24 further comprising the gaming machine saving in memory the new pay line and downloading the new pay line to another gaming machine for use by the player in the another gaming machine.

28. The method of claim 24 wherein changing the at least one pay line is controlled by the player.

29. The method of claim 24 wherein the triggering event is the display of a trigger symbol in the array of symbols.

30. The method of claim 24 wherein the triggering event is the display of a triggering combination of symbols in the array of symbols.

31. The method of claim 24 wherein the triggering event is the occurrence of a certain number of losing games played.

32. The method of claim 24 wherein the triggering event is the occurrence of a certain number of games played.

33. The method of claim 24 wherein the triggering event is a random time period.

34. The method of claim 24 wherein the triggering event is a certain time period.

35. A gaming device comprising:
a display area for displaying a game including an initial game, the initial game displaying an array of symbols on a screen, certain combinations of symbols across at least one pay line determining an award to a player;
at least one processor for carrying out the following method:
detecting a triggering event;
carrying out a function associated with the triggering event, the function comprising changing the array of symbols to create a different arrangement of symbols to provide the player another chance to obtain a winning symbol combination; and
granting an award to the player for any winning combinations of symbols.
